(19) United States
(12) Patent Application Publication
(10) Pub. No.: US 2024/0396475 A1
(43) Pub. Date: Nov. 28, 2024

(54) Garage Door Opener Having Battery Backup System with Extended Standby Mode

(71) Applicant: Doug Klassen, Holland, MI (US)

(72) Inventor: Doug Klassen, Holland, MI (US)

(21) Appl. No.: 18/200,025

(22) Filed: May 22, 2023

(51) Int. Cl. H02N 11/00; E05F 15/673; H02J 7/00

(52) U.S. Cl. CPC H02N 11/002; E05F 15/673; H02J 7/0042; E05Y 2400/614; E05Y 2800/252; E05Y 2900/106

(57) ABSTRACT

A garage door opener assembly, for opening and closing a garage door, including: a garage door, wherein the garage door is displaceable between open and closed positions; a motor, wherein the motor drives at least one of a screw shaft, a belt, and a chain and, in turn, a door opener arm secured to the garage door; a battery backup unit, wherein the battery backup unit includes a secondary electrochemical cell in electrical communication with the motor; and a kinetic energy charger, wherein the kinetic energy charger is in electrical communication with the secondary electrochemical cell.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to garage door openers for residential, commercial, and/or industrial applications, and, more particularly, to garage door openers having a battery backup system that is integrated with a kinetic energy and/or inertia charger to extend the standby life of the backup battery during normal operation.

By way of background, a garage door opener normally uses AC current from a conventional outlet. If a power outage occurs, and the garage door opener is not equipped with a battery backup, then the garage door cannot be opened unless the facility has a service door which allows access to the garage door opener for manual/emergency operation thereof. As such, battery backup systems for garage door openers have become relatively common. Having said that, the battery backup systems remain problematic because they lose capacity quickly-especially in real world, cold weather environments. Unless the backup battery is diligently replaced (and most homeowners are not “diligent” in doing so), they do not have the requisite stored energy and/or capacity to open the garage door during, for example, a power outage or other emergency situation. The garage door openers of the present invention are integrated with a kinetic energy charger so that each time the garage door is closed, the backup battery is charged, thereby extending its standby mode so that it has the requisite stored energy and/or capacity to open the garage door during a power outage-even if the homeowner isn't diligent in replacing the backup battery.

### 2. Background Art

Garage door openers and associated components have been known in the art for years and are the subject of a plurality of patents and publications, including: U.S. Pat. No. 11,503,147 entitled “Near Field Communications Activated Door Access Panel,” U.S. Pat. No. 10,237,996 entitled “Modular Garage Door Opener,” U.S. Pat. No. 9,811,958 entitled “Apparatus Enabling Secure Wireless Access to an Enclosure,” U.S. Pat. No. 8,527,101 entitled “Door Closer Assembly,” U.S. Pat. No. 8,113,263 entitled “Barrier Operator with Magnetic Position Sensor,” U.S. Pat. No. 7,600,550 entitled “Automatic Barrier Operation System,” U.S. Pat. No. 7,310,911 entitled “Automatic Door Opener with Magnetic Clutch,” U.S. Pat. No. 5,790,948 entitled “Method and Apparatus for Transmitter for Universal Garage Door Opener,” U.S. Pat. No. 5,596,840 entitled “Garage Door Opener with Remote Safety Sensors,” and United States Patent Application Publication Number 2018/0266172 entitled “Garage Door Systems and Methods”-all of which are hereby incorporated herein by reference in their entirety including all references cited therein.

U.S. Pat. No. 11,503,147 appears to disclose an access control apparatus for a barrier movement system that moves a barrier. The access control apparatus includes a near field communications (NFC) module, a radiofrequency (RF) module, and a controller coupled to the NFC module and RF module. The controller is configured to read an NFC signal from an authenticated external device, via the NFC module. In response to reading the NFC signal, the controller transmits a command signal, via the RF module, that commands the barrier movement system to move the barrier.

U.S. Pat. No. 10,237,996 appears to disclose a modular garage door opener system and method that includes a garage door opener having a motor that is configured to be coupled to a garage door to open and close the garage door. The garage door opener includes a first accessory port including a first accessory mounting interface and a second accessory port disposed on the garage door opener including a second accessory mounting interface. An accessory device including a first mounting interface engages the first accessory mounting interface to couple the accessory device to the first accessory port. The accessory device may be disengaged from the first accessory mounting interface and then engage the second accessory mounting interface to couple the accessory device to the second accessory port. Additionally, a second accessory device may engage the first accessory port after disengagement of the accessory device.

U.S. Pat. No. 9,811,958 appears to disclose an apparatus for more efficiently enabling secure access to an enclosure. The apparatus may include a wireless transmitter in a selectably opaque container, a wireless transceiver, a GPS receiver, an NFC transmitter and/or receiver, one or more hardware processors, and hardware memory. The hardware memory stores instructions for receiving a current location of the apparatus and comparing that location to a delivery address of the enclosure. As the location is within a certain range of the delivery address the apparatus sends a request to a cloud-based server for a hash digest masking an acceptable input for an access control mechanism associated with the enclosure. The apparatus receives the hash digest and forwards it to the access control mechanism via the wireless transmitter. Computer executable code for handling such tasks, and a cloud-based server for generating the hash digest, are also described therein.

U.S. Pat. No. 8,527,101 appears to disclose a door closer that comprises a piston cooperating with a rotating pinion. Upon rotation of the pinion in the door opening direction, the piston moves toward the second end of the housing forcing fluid from a second variable volume chamber through a passage to a first variable volume chamber and compressing a spring assembly for storing energy. The spring assembly urges the piston toward the first end of the housing for forcing fluid from the first variable volume chamber to the second variable volume chamber and rotating the pinion in the door closing direction. A controller controls the position of a valve in the passage based on the sensed angular position of a door and the position of the valve for determining the amount of hydraulic fluid flowing through the valve.

U.S. Pat. No. 8,113,263 appears to disclose a motorized operator for moving a barrier, such as a garage door, between open and closed positions, that includes a magnetic sensor for determining position and/or velocity of the barrier. The operator motor is drivingly connected to a speed change transmission which is connected to the barrier. The magnetic sensor includes a housing supporting a speed change mechanism including an output shaft supporting a magnet. The magnet is mounted adjacent a Hall effect sensor circuit which measures the change in the magnetic field generated by the magnet to determine position of the barrier, as well as speed. Control circuitry enables accurate determination of the position of the barrier for setting open and closed limit positions.

U.S. Pat. No. 7,600,550 appears to disclose an automatic barrier operator system for operating a gate or upward acting garage door, for example, includes a controller for operating a reversible motor, a base radio frequency transmitter and a base radio frequency receiver. One or more remote control units include a radio frequency remote receiver and remote transmitter. The controller is operable to automatically close or open the barrier in response to a query signal sent from the base transmitter to the remote receiver and when the remote receiver is within range, returning a signal to effect operation of the barrier. The system is operable to effect operation or maintain the status quo of the barrier depending on the state of the barrier and a particular signal or lack of signal received by the controller from an authorized remote control unit or units. The system provides essentially hands-free automatic operation of opening and closing a garage door and the like.

U.S. Pat. No. 7,310,911 appears to disclose an automatic door opener for opening or closing a door that includes a motor driving a drive shaft and an opener arm connected to the door and being responsive to rotation of the drive shaft for moving the door to an open or closed position. A clutch operable to disengage the drive shaft from the opener arm is provided in the event of the door engaging an obstacle, electric power being unavailable, or the door being fully open or fully closed. The door opener may also include a brake for selectively preventing movement of the door. Various embodiments of the invention are provided, including an electromagnet and an electromagnetic brake.

U.S. Pat. No. 5,790,948 appears to disclose a universal remote control transmitter for use with garage door openers including a number of switches whereby a user can program a transmitted modulation format and carrier frequency, and a controller for scanning the switches to determine the user programmed selections. The controller, in response to the programmed selections, outputs the required modulation to a selected transmitter, as well as direction to fine tune the transmitter to the particular carrier frequency. Also included is a power sensor circuit that responds to a change in power supply voltage by adjusting the modulation to maintain a constant peak transmitter output power.

U.S. Pat. No. 5,596,840 appears to disclose an automatic door opening safety system particularly for use with garage doors. The garage door includes a leading edge that moves from the open position, where the leading edge defines the top of the opening and a closed position, where the leading edge contacts the ground. A controller is provided for controlling movement of the door. An activation member provides an input to the controller to initiate movement of the door. A detection member is provided for detecting obstructions in the path of the garage door. The detection member includes an infrared transmitter for transmitting an infrared signal to the infrared receiver of the controller.

United States Patent Application Publication Number 2018/0266172 appears to disclose a plurality of door panels and a frame, the door panels being movable between an extended position closing an opening in a building structure, and a folded retracted position. When in the extended position, the door panels interlock with each other forming a barrier to wind, dirt, dust and insects. The frame is movably attached to the building structure and when the door panels are in the extended position, the frame moves and engages the door panels with a sealing member to provide an airtight seal of the opening in the building structure.

While the above-identified patents and publications do appear to disclose various garage door opener assemblies, their configurations remain non-desirous and/or problematic inasmuch as, among other things, none of the above-identified garage door openers appear to have a battery backup system that is integrated with a kinetic energy and/or inertia charger to extend the standby life of the backup battery during normal operation.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention is directed to a garage door opener assembly, for opening and closing a garage door, comprising, consisting essentially of and/or consisting of: (a) a garage door, wherein the garage door includes at least one hinge and a plurality of wheels, and wherein the garage door is displaceable between open and closed positions; (b) left and right tracks, wherein the left and the right tracks collectively retain the plurality of garage door wheels; (c) left and right cable drums, wherein the left and the right cable drums contain cable in communication with the garage door; (d) a torsion rod, wherein the torsion rod is secured to and positioned between the left and the right cable drums; (e) a torsion spring, wherein the torsion spring is associated with the torsion rod; (f) a motor, wherein the motor drives at least one of a screw shaft, a belt, and a chain and, in turn, a door opener arm secured to the garage door; (g) a trolly track, wherein the trolly track houses the screw shaft, belt and/or chain; (h) a battery backup unit, wherein the battery backup unit comprises a secondary electrochemical cell in electrical communication with the motor; and (i) a kinetic energy charger, wherein the kinetic energy charger is in electrical communication with the secondary electrochemical cell.

In a preferred embodiment of the present invention, the kinetic energy charger comprises a linear kinetic energy charger. In this embodiment, the linear kinetic energy charger is preferably associated with the door opener arm.

In another preferred embodiment of the present invention, the kinetic energy charger comprises a vibrational kinetic energy charger. In this embodiment, the vibrational kinetic energy charger is preferably associated with the motor.

In yet another preferred embodiment of the present invention, the kinetic energy charger comprises a torsional kinetic energy charger. In this embodiment, the torsional kinetic energy charger is preferably associated with the torsion rod, the torsion spring, the left cable drum and/or the right cable drum.

In one preferred embodiment of the present invention, the kinetic energy charger comprises a compressional kinetic energy charger. In this embodiment, the compressional kinetic energy charger is preferably associated with the garage door.

In a preferred implementation of the present invention, the garage door opener assembly further comprises a wall mounted door controller.

In another preferred implementation of the present invention, the garage door opener assembly further comprises a remote door controller.

In yet another preferred implementation of the present invention, the garage door opener further comprises a manual/emergency release cord.

In one preferred implementation of the present invention, the garage door opener assembly further comprises a non-contact reversing system.

The present invention is also directed to a garage door opener assembly, for opening and closing a garage door, comprising, consisting essentially of and/or consisting of: (a) a garage door, wherein the garage door is displaceable between open and closed positions; (b) a motor, wherein the motor drives at least one of a screw shaft, a belt, and a chain and, in turn, a door opener arm secured to the garage door; (c) a battery backup unit, wherein the battery backup unit comprises a secondary electrochemical cell in electrical communication with the motor; and (d) a kinetic energy charger, wherein the kinetic energy charger is in electrical communication with the secondary electrochemical cell.

In a preferred embodiment of the present invention, the kinetic energy charger comprises a linear kinetic energy charger, a vibrational kinetic energy charger, a torsional kinetic energy charger, and/or a compressional kinetic energy charger.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1 of the drawings is a perspective view of an embodiment of a garage door opener assembly of the present invention;

FIG. 2 of the drawings is a perspective view of an embodiment of a garage door opener assembly of the present invention shown in the open position;

FIG. 3 of the drawings is a perspective view of an embodiment of a garage door opener assembly of the present invention shown in the closed position;

FIG. 4 of the drawings is a fragmented perspective view of an embodiment of a garage door opener assembly of the present invention showing the drive motor, battery backup unit, and the kinetic energy charger; and

FIG. 5 of the drawings is a fragmented perspective view of an embodiment of a garage door opener assembly of the present invention showing certain details of the drive motor.

### DETAILED DESCRIPTION OF THE INVENTION

While this invention is susceptible of embodiment in many different forms and applications, there are shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

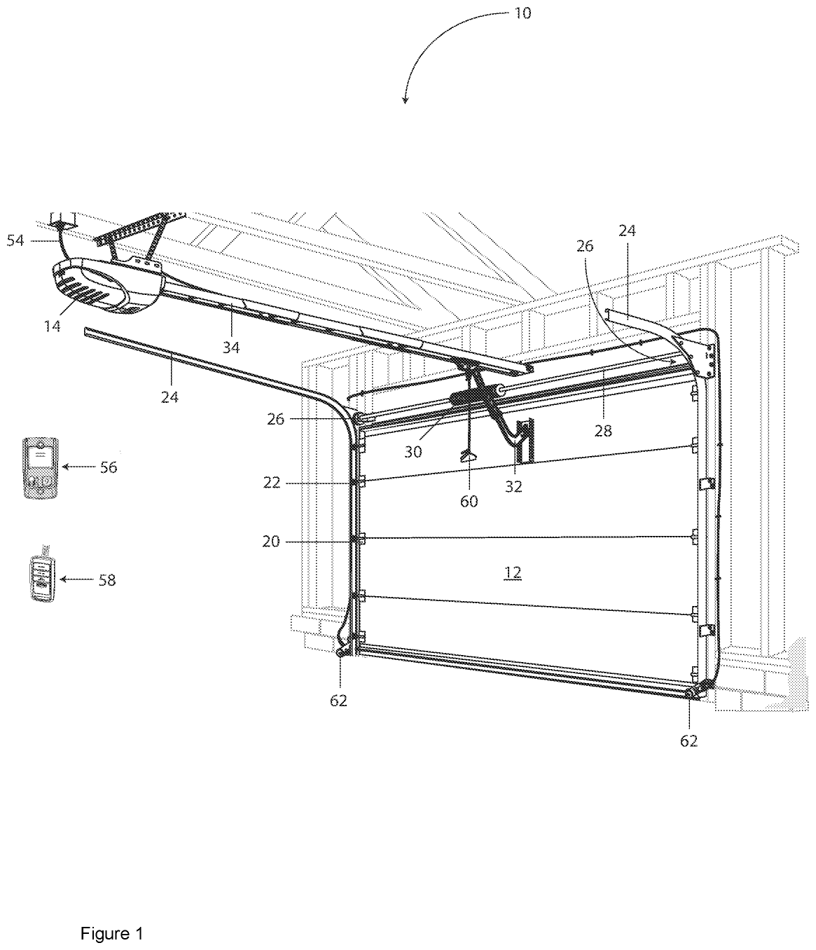

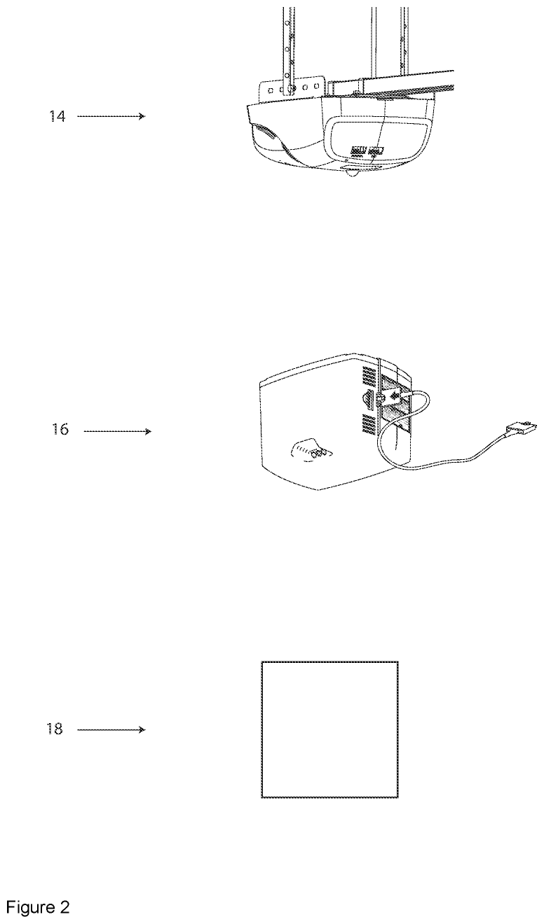

Referring now to the drawings, and to FIGS. 1-2 in particular, a first embodiment of garage door opener assembly 10, for opening and closing a garage door, is shown as generally comprising: garage door 12, motor/drive unit 14, battery backup unit (BBU) 16, and inertia and/or kinetic energy charger 18. The garage door opener assemblies of the present invention utilize a battery backup system that is associated and/or integrated with a kinetic energy and/or inertia charger to extend the standby life of the backup battery during normal operation. This allows for normal operation of the garage door during a power outage-even if the backup battery is not diligently changed.

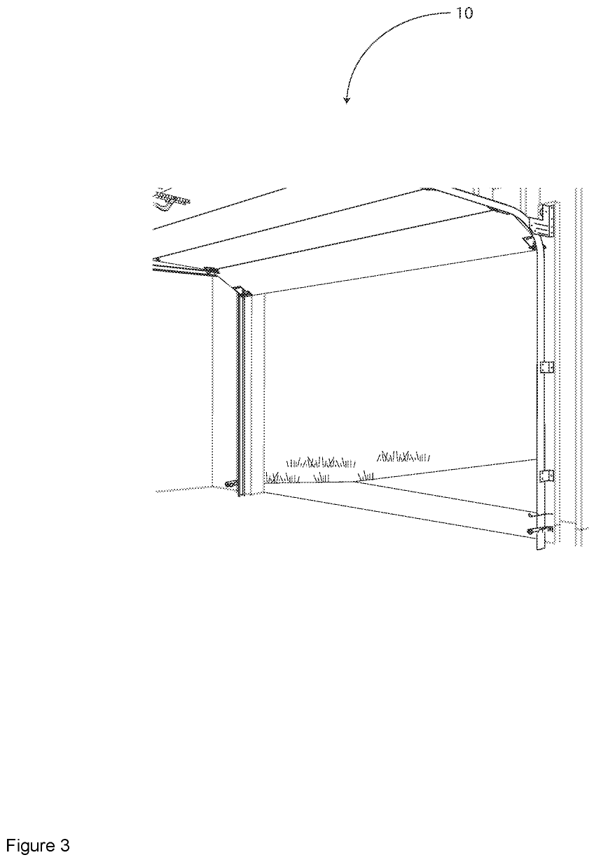

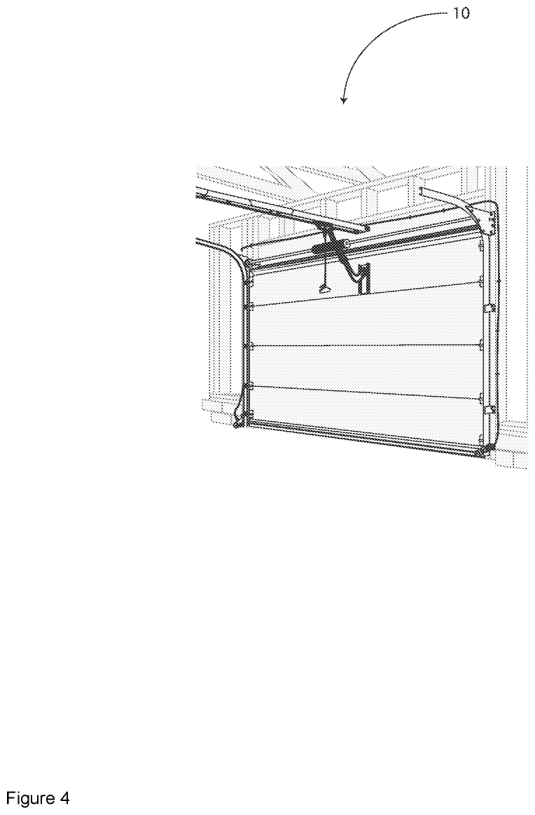

Garage door 12 is displaceable between an open position (See FIG. 3) and a closed position (See FIG. 4). Preferably, garage door 12 includes one or more hinges 20 and a plurality of wheels 22. It will be understood that garage door 12 may comprise any barrier that is opened and closed, such as a gate, a window, a door, etcetera.

Garage door opener assembly 10 preferably includes left and right tracks 24. These tracks collectively retain the plurality of rolling garage door wheels 22 during normal operation.

In one implementation of the present invention, garage door opener assembly 10 includes left and right cable drums 26. These cable drums hold/contain cable which is in mechanical communication with garage door 12.

Preferably, garage door opener assembly 10 includes torsion rod 28. Torsion rod 28 is secured to and positioned between left and right cable drums 26.

Garage door opener assembly 10 also preferably includes torsion spring 30, which is associated with the torsion rod.

In a preferred embodiment of the present invention, garage door opener assembly 10 includes motor/drive unit 14. Motor 14 preferably drives a screw, a shaft, a belt, and/or a chain and, in turn, door opener arm 32, which is secured to garage door 12. Trolly track 34 houses the screw, the shaft, the belt and/or the chain during normal operation.

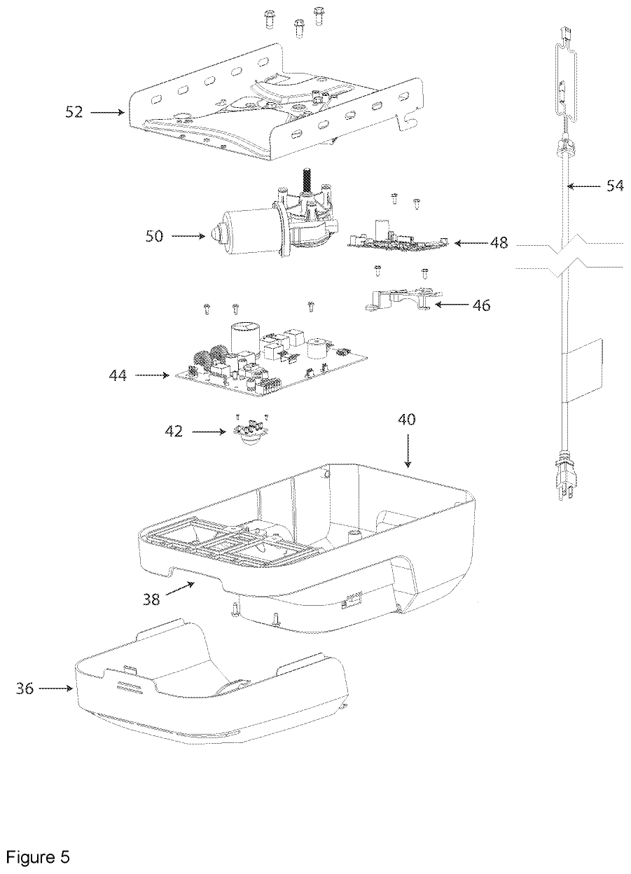

Referring now to FIG. 5, motor/drive unit 14 generally includes light lens cover 36, light socket assembly 38, power head cover 40, motion detector module 42, integrated circuit board/printed circuit board 44, Wi-Fi mounting bracket 46, Wi-Fi module 48, motor assembly 50, top housing 52, and power cord 54.

Referring now again to FIGS. 1-3, in accordance with the present invention, garage door opener assembly 10 includes battery backup unit 16. Preferably, battery backup unit 16 includes a secondary electrochemical cell in electrical communication with motor/drive unit 14 so that the garage door can be opened during, for example, a power outage, brown out, etcetera. The secondary electrochemical cell, may comprise, for example, an alkaline, a lead acid, a nickel-cadmium, a nickel metal hydride, a lithium-ion, and/or lithium-ion polymer secondary electrochemical cell.

In one embodiment of the present invention, garage door opener assembly 10 also preferably includes wall mounted door controller 56, remote door controller 58, manual release cord/safety 60, and/or non-contact reversing system 62.

As discussed supra, garage door opener assembly 10 also includes inertia/kinetic energy charger 18, which is preferably in electrical communication with the secondary electrochemical cell of BBU 16. Each time garage door 12 is raised and/or lowered (depending on the configuration), inertia/kinetic energy charger 18 charges the secondary electrochemical cell in BBU 16. This enables the garage door opener assembly to have an extended standby mode even if the battery is not changed as often as recommended. Non-limiting examples of inertia/kinetic energy chargers include those disclosed in, for example, U.S. Pat. No. 7,956,753, entitled “Tether Apparatus,” U.S. Pat. No. 6,794,783, entitled “Flat rotary electric generator,” U.S. Pat. No. 6,717,297, entitled “Electrical machine,” U.S. Pat. No. 5,631,507, entitled “Electric power generator,” U.S. Pat. No. 5,608,279, entitled “DC generator,” U.S. Pat. No. 5,347,186, entitled “Linear motion electric power generator,” U.S. Pat. No. 5,089,734, entitled “Dual rotary AC generator,” U.S. Pat. No. 4,500,827, entitled “Linear reciprocating electrical generator,” U.S. Pat. No. 4,385,246, entitled “Apparatus for producing electrical energy,” U.S. Pat. No. 4,217,508, entitled “DC motor,” and U.S. Pat. No. 3,673,444, entitled “Rotary electric machine,”-all of which are hereby incorporated herein by reference in their entirety including all references cited therein.

In a preferred embodiment of the present invention, the kinetic energy charger comprises one or more linear kinetic energy chargers preferably associated with, secured to, connected to, and/or forms part of the garage door, the door opener arm, and/or any other component of the garage door opener assembly.

In another preferred embodiment of the present invention, the kinetic energy charger comprises one or more vibrational kinetic energy chargers preferably associated with, secured to, connected to, and/or forms part of the motor assembly, the garage door, the door opener arm, and/or any other component of the garage door opener assembly.

In yet another preferred embodiment of the present invention, the kinetic energy charger comprises one or more torsional kinetic energy chargers preferably associated with, secured to, connected to, and/or forms part of the motor assembly, the torsion rod, the torsion spring, the left cable drum, the right cable drum, and/or any other component of the garage door opener assembly.

In yet another preferred embodiment of the present invention, the kinetic energy charger comprises one or more compressional kinetic energy chargers preferably associated with, secured to, connected to, and/or forms part of the garage door, the door opener arm, and/or any other component of the garage door opener assembly.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A garage door opener assembly, for opening and closing a garage door, comprising:
a garage door, wherein the garage door includes at least one hinge and a plurality of wheels, and wherein the garage door is displaceable between open and closed positions;
left and right tracks, wherein the left and the right tracks collectively retain the plurality of garage door wheels;
left and right cable drums, wherein the left and the right cable drums contain cable in communication with the garage door;
a torsion rod, wherein the torsion rod is secured to and positioned between the left and the right cable drums;
a torsion spring, wherein the torsion spring is associated with the torsion rod;
a motor, wherein the motor drives at least one of a screw shaft, a belt, and a chain and, in turn, a door opener arm secured to the garage door;
a trolly track, wherein the trolly track houses the screw shaft, belt and/or chain;
a battery backup unit, wherein the battery backup unit comprises a secondary electrochemical cell in electrical communication with the motor; and
a kinetic energy charger, wherein the kinetic energy charger is in electrical communication with the secondary electrochemical cell.

2. The garage door opener assembly according to claim 1, wherein the kinetic energy charger comprises at least one linear kinetic energy charger.

3. The garage door opener assembly according to claim 2, wherein the at least one linear kinetic energy charger is associated with the door opener arm.

4. The garage door opener assembly according to claim 1, wherein the kinetic energy charger comprises at least one vibrational kinetic energy charger.

5. The garage door opener assembly according to claim 4, wherein the at least one vibrational kinetic energy charger is associated with the motor.

6. The garage door opener assembly according to claim 1, wherein the kinetic energy charger comprises at least one torsional kinetic energy charger.

7. The garage door opener assembly according to claim 6, wherein the at least one torsional kinetic energy charger is associated with the torsion rod.

8. The garage door opener assembly according to claim 6, wherein the at least one torsional kinetic energy charger is associated with the torsion spring.

9. The garage door opener assembly according to claim 6, wherein the at least one torsional kinetic energy charger is associated with the left or right cable drum.

10. The garage door opener assembly according to claim 1, wherein the kinetic energy charger comprises at least one compressional kinetic energy charger.

11. The garage door opener assembly according to claim 10, wherein the at least one torsional kinetic energy charger is associated with the garage door.

12. The garage door opener assembly according to claim 1, further comprising a wall mounted door controller.

13. The garage door opener assembly according to claim 1, further comprising a remote door controller.

14. The garage door opener assembly according to claim 1, further comprising a manual release cord.

15. The garage door opener assembly according to claim 1, further comprising a non-contact reversing system.

16. A garage door opener assembly, for opening and closing a garage door, comprising:
a garage door, wherein the garage door is displaceable between open and closed positions;
a motor, wherein the motor drives at least one of a screw shaft, a belt, and a chain and, in turn, a door opener arm secured to the garage door;
a battery backup unit, wherein the battery backup unit comprises a secondary electrochemical cell in electrical communication with the motor; and
a kinetic energy charger, wherein the kinetic energy charger is in electrical communication with the secondary electrochemical cell.

17. The garage door opener assembly according to claim 1, wherein the kinetic energy charger comprises a linear kinetic energy charger, a vibrational kinetic energy charger, a torsional kinetic energy charger, and/or a compressional kinetic energy charger.
